(19) United States
(12) Patent Application Publication
(10) Pub. No.: US 2007/0170660 A1
(43) Pub. Date: Jul. 26, 2007

(54) Heat exchanger seal

(76) Inventors: Michael J. Burgess, Cottontown, TN (US); Thomas M. Houck, Marietta, OH (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/606,559

(22) Filed: Nov. 30, 2006

Related U.S. Application Data
(60) Provisional application No. 60/741,164, filed on Dec. 1, 2005.

(51) Int. Cl. F02F 11/00

(52) U.S. Cl. 277/596; 165/149

(57) ABSTRACT

A seal for use between two metal surfaces and allowing relative motion between the two surfaces during thermal cycling. The seal comprises a non-extrudable packing layer adjacent to a first end of the seal assembly. The seal further comprises one or more elastomeric O-rings, one or more load distribution packing layers, one or more braided plastic packing layers having elastomeric cores, with a non extrudable packing layer adjacent to a braided plastic packing layer and disposed at a second end of the seal and, optional additional non extrudable packing layers.

This application claims the benefit of U.S. Application No. 60/741,164, filed Dec. 1, 2005.

### FIELD OF THE INVENTION

The present invention relates to shell and tube type heat exchangers and more particularly to packing methods for floating tube sheet type exchangers.

### BACKGROUND OF THE INVENTION

A conventional shell and tube type heat exchanger comprises generally a tubular shell or casing having a pair of inlet/outlet pipes through which a first fluid is passed, and a tubestack received within the casing. The tubestack is composed of generally parallel tube elements through which a second fluid is passed for heat exchange with the above-mentioned first fluid, the tube elements extending between and being supported by a pair of support members or tube plates. The tubestack also includes a plurality of baffles disposed between the tube plates and extending transversely to the tube elements.

The second fluid is supplied to the tubestack by means of inlet/outlet ports in respective covers that are secured to the casing by any convenient means, such as by bolted flanges or bolt and lug arrangements provided on these parts. To prevent intermixing of first and second fluids, at one end of the heat exchanger a suitable sealing arrangement surrounding the tubeplate is interposed between the cover and the casing, whilst at the other end of the heat exchanger the tubeplate is provided with an extended flange carrying respective packings likewise disposed between the cover and the casing. The flange also serves as an abutment relative to the casing and serves to locate the tubestack axially within the casing.

During the operation of the system, heat transfer would occur between the first and second fluids since in many applications, it would be disadvantageous to have the material on the inside of the tubes commingle with the material on the exterior. For this reason, it is imperative that there be a very tight seal between each of the tubes and the metal tube sheets. Furthermore, since the temperatures in the parallel tubes reach high levels, it is necessary to allow the tubes to undergo expansion and subsequent contraction without rupturing the mechanical seals between the parallel tubes and the tube sheets. One way of relieving thermal stresses is to use a floating head design in which one end of the tubestack is held in a tube sheet that is allowed to move relative to the shell during thermal cycles.

Several different designs of floating head shell and tube heat exchanges are in common use. Although each design accomplishes the goal of relieving thermal stress on the exchanger, each configuration has a different set of drawbacks.

The simplest design is the “pull through bundle” type in which one of the tube sheets is made small enough that it and its gasketed bonnet can be pulled completely through the shell for shell side inspection and cleaning. The disadvantage with this design is that many tubes must be omitted from the edge of the bundle to allow for the bonnet flange and bolt circle.

Other types of floating head designs that restore the omitted tubes include what are known in the art as “split ring floating head”, “outside packed lantern ring floating head” and outside packed stuffing box floating head”. Each of these suffers primarily from the disadvantage that they are difficult to seal and are prone to leakage at the tube bundle to shell joint.

It is desirable that the present invention overcomes these disadvantages.

The following disclosures may be relevant to various aspects of the present invention and may be briefly summarized as follows:

U.S. Pat. No. 6,406,028 discloses a seal stack that comprises first v-ring seals adapted to seal in at least a first range of temperatures. The first v-ring seals comprise at least one primary v-ring seal and at least one secondary v-ring seal, where at least one of the secondary v-ring seals is substantially less flexible than any of the primary v-ring seals to support the primary v-ring seals. A second seal is adjacent to one of the first v-ring seals, the second seal adapted to seal in at least a lower range of temperatures than the first range of temperatures.

U.S. Pat. Nos. 5,788,216 and 5,549,276 describe packing consisting of a plurality of individual rings including a male adapter, a female adapter, and one chevron seal ring consisting essentially of perfluoroelastomer positioned between the male adapter and the female adapter, the chevron seal ring being pointed toward the atmospheric end of the packing. The male and female adapters consisting essentially of polymeric resins stable at high temperature selected from the group consisting of a substantially non-elastomeric fluoropolymer and a polyetheretherketone, and the chevron seal ring is disposed between and contacting the male and female adapters. The packing has an improved sealing performance.

U.S. Pat. No. 5,542,681 describes a graphite packing material.

U.S. Pat. No. 5,297,805 describes a sealing ring that comprises an elastomeric body having a waisted cross section, and a reinforced face such that a portion of said sealing ring is less flexible than the remainder of said sealing ring. The elastomeric body provides a first set of contact surfaces for forming a seal, and wherein said reinforced face provides a second set of contact surfaces for forming a seal distinct and spaced apart from said first set of contact surfaces.

### SUMMARY OF THE INVENTION

Briefly stated, and in accordance with one embodiment of the present invention, there is provided:

(i) a hollow casing through which a first fluid is passed,

(ii) a tubestack disposed within the casing and including a plurality of tube elements through which a second fluid is passed for heat exchange with said first fluid,

(iii) a sealing system in turn comprising a heat exchanger tubesheet, a plurality of said tube elements extending through openings in said heat exchanger tubesheet, each tube element having a bore through which materials flow for exchanging heat between the tube element and the surrounding area, and a multilayer seal assembly disposed between the tubesheet and the casing, the multilayer seal assembly comprises:
a) a non-extrudable packing layer adjacent to a first end of the seal assembly;
b) one or more elastomeric O-rings, each O-ring being disposed adjacent to at least one non extrudable packing layer such that an elastomeric O-ring is adjacent to the non-extrudable packing layer that is adjacent to the first end of the seal assembly;
c) one or more braided plastic packing layers having elastomeric cores;
d) a non-extrudable packing layer adjacent to a braided plastic packing layer and disposed at a second end of the seal; and,
e) optionally, additional non-extrudable packing layers.

In a further embodiment of the heat exchanger, the non-extrudable packing layers can comprise a braided metal.

In a still further embodiment of the heat exchanger of the invention, the load distribution packing layers can comprise a braided metal.

In a still further embodiment of the heat exchanger of the invention, the one or more braided plastic packing layers can comprise PTFE.

In a still further embodiment of the heat exchanger of the invention, the non extrudable packing layer adjacent to a second end of the seal comprises a braided plastic packing with metal wire.

In a still further embodiment of the heat exchanger of the invention the elastomeric core comprises a silicone rubber.

Pursuant to another aspect of the present invention, there is provided a seal assembly for use between two metal surfaces during thermal cycling, said seal assembly comprising:
a) a non-extrudable packing layer adjacent to a first end of the seal assembly,
b) one or more elastomeric O-rings, each O-ring being disposed adjacent to at least one non-extrudable packing layer such that an elastomeric O-ring is adjacent to the non-extrudable packing layer that is adjacent to the first end of the seal assembly;
c) one or more braided plastic packing layers having elastomeric cores;
d) a non-extrudable packing layer adjacent to a braided plastic packing layer and disposed at a second end of the seal and; and
e) optionally, additional non-extrudable packing layers.

### BRIEF DESCRIPTION OF THE DRAWINGS

The invention will be more fully understood from the following detailed description, taken in connection with the accompanying drawings in which:

FIG. 1 shows a detailed cross section of an embodiment of a seal of the invention.

FIG. 2 shows a schematic diagram of the cross section of a heat exchanger of the invention.

While the present invention will be described in connection with a preferred embodiment thereof, it will be understood that it is not intended to cover all alternatives, modifications, and equivalents as may be included within the spirit and scope of the invention as defined by the appended claims.

### DETAILED DESCRIPTION OF THE INVENTION

The seal assembly of the invention can be used to seal between any two metal surfaces in which it is required to allow relative motion between the two surfaces during thermal cycling. An embodiment of the invention is suitable for use as a seal assembly in a floating head heat exchanger. The invention can best be understood by reference to the Figures.

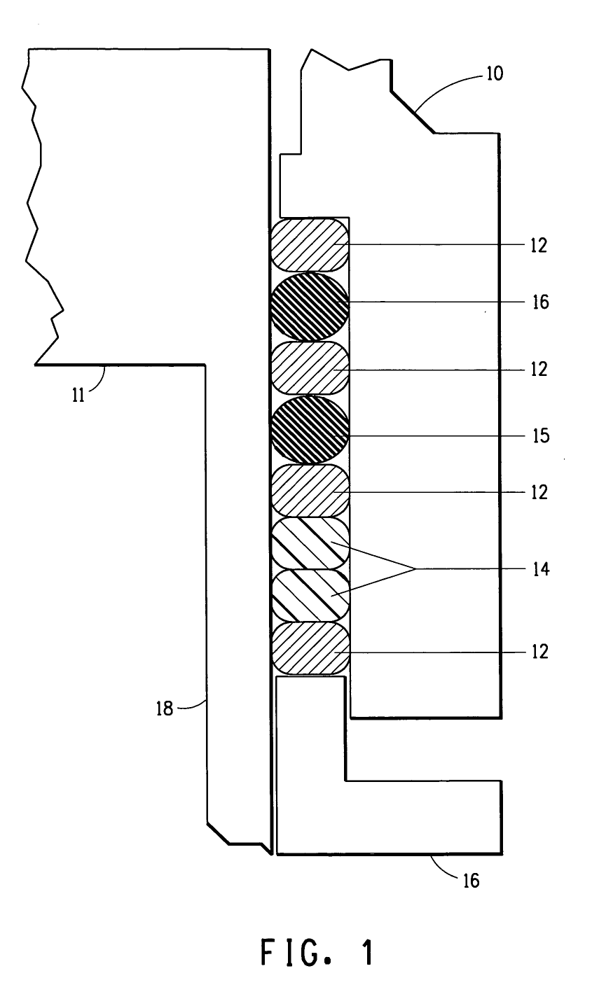

FIG. 1 shows an example of an embodiment of the seal assembly of the invention. The sealing system comprises the shell or other wall of the heat exchanger (10) which is required to be sealed against a tubesheet (11) which may have a skirt (18). The seal assembly (12-15) comprises non-extrudable packing layers (12) that can act as load distribution layers. At least one non-extrudable packing layer is disposed at each end of the seal assembly.

An example of a non-extrudable packing layer would be copper wire braided packing available from ChemStar Packing (Mulberry, Fla.) such as “style 49”. Any packing material can be used that does not flow or creep under the operating pressures and temperatures required in service. The seal assembly can optionally comprise additional non-extrudable packing layers (15) that act as load distribution layers. Another example of a non-extrudable packing layer would be braided plastic packing with metal wire. The metal used need not be limited to wire but could include other configurations such as ribbon-like.

The embodiment shown in FIG. 1 further comprises elastomeric O-rings (13). The present invention is not limited to one or even two O rings as shown. The number of O-rings can be as many as needed to give optimum sealing performance under the conditions of operation of the heat exchanger. One skilled in the art will be able to ascertain without undue experimentation the optimum number of O-rings and load distribution layers. Suitable materials are ‘O’ rings comprised of one or more elastomers and in particular fluoroelastomers such as Viton® (Du Pont, Wilmington, Del.) and Aflas® (Asahi Glass, Japan). In the embodiment of FIG. 1, one of the O-rings is adjacent to a non-extrudable packing layer, which is in turn at one end of the sealing assembly.

Load distribution layers may be used between two or more O-rings. It is not essential that the load distribution layers alternate for the present invention. Any arrangement in which a load distribution layer appears at each end of the seal assembly is within the scope of the present invention.

The embodiment shown in FIG. 1 further comprises braided plastic packing layers (14). The braided plastic packing layers comprise a braided polytetrafluoroethylene (PTFE) coating over an elastomeric core. The embodiment shown in FIG. 1 shows two braided plastic packing layers. However, the scope of the invention can include an assembly with one and any number of optional braided plastic packing layers 14, with the proviso that one braided plastic packing layer 14 is adjacent to one end of the seal assembly.

The packing follower (16) is an adjustment device to prevent leakage from the heat exchanger.

A suitable elastic core for the braided plastic packing layer (14) is a silicone rubber although the invention is not limited to silicone and any rubber that is suitable for the service requirements of the seal can be used. Examples of suitable PTFE packing are available from Sepco (Alabaster, Ala.) and Du Pont (Wilmington, Del.).

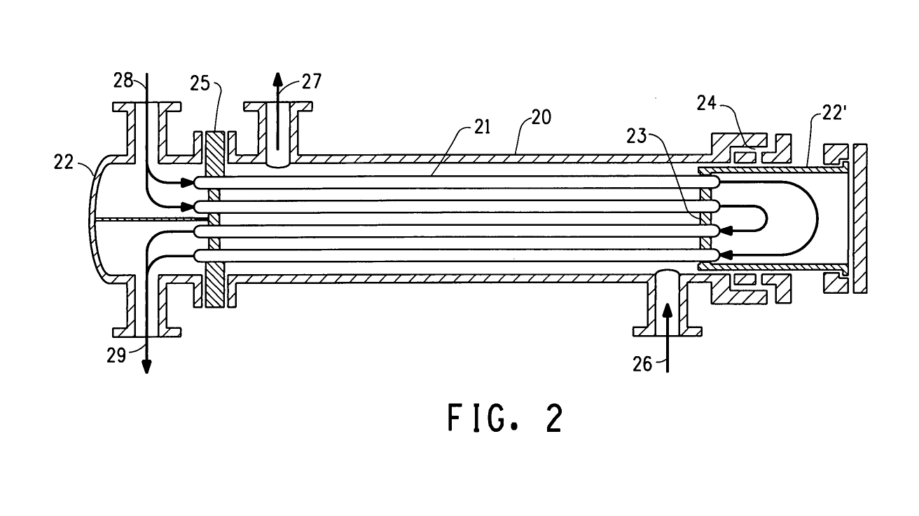

An embodiment of the present invention is also directed to a floating head heat exchanger that comprises any embodiment of the seal assembly of the present invention. Reference is now made to FIG. 2, a schematic diagram of the cross section of a floating head heat exchanger is shown. The heat exchanger comprises a hollow casing 20 through which a first fluid is passed. The casing has two ends 22,25. A tubestack 21 is disposed within the casing and comprises a plurality of tube elements through which a second fluid is passed for heat exchange with said first fluid. A tube bundle comprises the tubestack 21 and the casing ends 22, 25. One end of the tubestack is fixed by some means at one end 25, the means of fixture not being intended to be a limitation of the present invention. The tubes at the other end (22′) are free to move with thermal stresses. A sealing system in turn comprises a tubesheet 23 and a gap 24 into which the seal assembly (not shown in FIG. 2) of the invention is fixed, allowing motion of the tubesheet while providing a flexible seal with the shell 20. A plurality of said tube elements extend through openings in said heat tubesheet, each tube element having a bore through which materials flow for exchanging heat between the tube element and the surrounding area, and a seal assembly disposed in the gap 24 between the tubesheet and the casing. The seal assembly in turn comprises: a non-extrudable packing layer adjacent to a first end of the seal assembly; one or more elastomeric O-rings, where each O-ring being disposed adjacent to at least one non-extrudable packing layer such that an elastomeric O-rings is adjacent to the non-extrudable packing layer that is adjacent to the first end of the seal assembly; one or more braided plastic packing layers having elastomeric cores; a non-extrudable packing layer adjacent to a braided plastic packing layer and disposed at a second end of the seal; and optional additional non-extrudable packing layers that act as load distribution layers.

Reference numbers 28 and 29, show the tube's side fluid entrance and exit, respectively. The shell inlet is shown by reference number 26, and the shell outlet is shown by reference number 27.

The present invention substantially reduced the cost and amount of leakage of prior heat exchanger systems using multi-braided packing rings as the packing system. Three calandrias (i.e. reboilers) using the multi-braided packing rings seal system where compared to the O-ring seal assembly system of the present invention. The three calandrias of the multi-braided packing rings system required replacement of the packing system in all three calandrias about every two months to reduce leakage. The cost for maintenance for all three such calandrias was about $25,000/year. By comparison, using the O-ring seal assembly packing system of the present invention, in three calandrias, the leakage was not only reduced but stopped. Furthermore, no replacement of the packing system has been required in over two years. The annual cost of maintenance, which consists of periodic tightening of the packing, has been reduced to less than $1000/year. Thus, the present invention shows substantial improvement over the prior packing system.

It is therefore apparent that there has been provided in accordance with the present invention, an improved heat exchanger seal that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A heat exchanger comprising:
(i) a hollow casing through which a first fluid is passed;
(ii) a tubestack disposed within the casing and having a plurality of tube elements through which a second fluid is passed for heat exchange with said first fluid; and
(iii) a sealing system comprising a heat exchanger tubesheet, having a plurality of said tube elements extending through openings in said heat exchanger tubesheet, each tube element having a bore through which materials flow for exchanging heat between the tube element and the surrounding area, and a multilayer seal assembly disposed between the heat tubesheet and the casing, said multilayer seal assembly comprising:
a) a non-extrudable packing layer adjacent to a first end of the seal assembly;
b) one or more elastomeric O-rings, each O-ring being disposed adjacent to at least one non-extrudable packing layer such that the one or more elastomeric O-rings is adjacent to the non-extrudable packing layer that is adjacent to the first end of the seal assembly;
c) one or more braided plastic packing layers having elastomeric cores;
d) a non-extrudable packing layer adjacent to a braided plastic packing layer and disposed at a second end of the seal; and,
e) optionally, additional non-extrudable packing layers.

2. The heat exchanger of claim 1 in which at least one of the non-extrudable packing layers comprises a braided metal.

3. The heat exchanger of claim 1 in which at least one of the load distribution packing layers comprises a braided metal.

4. The heat exchanger of claim 1 in which at least one of the one or more braided plastic packing layers comprise PTFE.

5. The heat exchanger of claim 1 in which the non-extrudable packing layer adjacent to a second end of the seal comprises a braided plastic packing with metal wire.

6. The heat exchanger of claim 1 in which the elastomeric core comprises a silicone rubber.

7. A seal assembly for use between two metal surfaces and allowing relative motion between the two surfaces during thermal cycling, said seal assembly comprising;
a) a non-extrudable packing layer adjacent to a first end of the seal assembly;
b) one or more elastomeric O-rings, each O-ring being disposed adjacent to at least one non-extrudable packing layer such that one or more elastomeric O-rings is adjacent to the non-extrudable packing layer that is adjacent to the first end of the seal assembly;
c) one or more braided plastic packing layers having elastomeric cores;
d) a non-extrudable packing layer adjacent to a braided plastic packing layer and disposed at a second end of the seal; and
e) optionally, additional non-extrudable packing layers.

8. The seal assembly of claim 7 in which at least one of the non-extrudable packing layers comprises a braided metal.

9. The seal assembly of claim 7 in which at least one of the load distribution packing layers comprises a braided metal.

10. The seal assembly of claim 7 in which at least one of the one or more braided plastic packing layers comprise PTFE.

11. The seal assembly of claim 7 in which the non-extrudable packing layer adjacent to a second end of the seal comprises a braided plastic packing with metal wire.

12. The seal assembly of claim 7 in which the elastomeric core comprises a silicone rubber.
